(19) United States
(12) Patent Application Publication
(10) Pub. No.: US 2007/0106805 A1
(43) Pub. Date: May 10, 2007

(54) System and method for peer-to-peer digital content sharing

(76) Inventors: David Marples, Mansfield (GB); Stanley Moyer, Mendham, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 11/591,337

(22) Filed: Nov. 1, 2006

Related U.S. Application Data
(60) Provisional application No. 60/732,017, filed on Nov. 1, 2005.

(51) Int. Cl. G06F 15/16

(52) U.S. Cl. 709/229

(57) ABSTRACT

This invention uses the ability of a digital content mediator (“DCM”) to track the distribution of digital content—i.e., authenticate the source and destination users/devices, and authorize the transfer based on the specified policies for the identified content. This tracking creates an undisputable audit trail that can be used for authorization and billing purposes. In addition, content that is moved within one home or between devices owned by the same person can be done for “free” as per the fair use provision of the copyright act—the DCM will verify that the devices are in the same home and/or owned by the same person and allow the transfer.

### CROSS REFERENCE TO RELATED APPLICATION

This application claims the benefit of U.S. Provisional Patent Application No. 60/732,017, filed Nov. 1, 2005, the disclosure of which is hereby incorporated herein by reference.

### FIELD OF THE INVENTION

The present invention relates generally to the field of digital content distribution between different devices in a network and specifically, to tracking the exchange of digital content in a peer-to-peer network so that rights owners of the content can be compensated, distribution can be tracked, demographic determination of sources and recipients of the content, server resource provisioning, uptake forecasting and the like.

### BACKGROUND OF THE INVENTION

As telecommunications carriers evolve toward becoming broadband communications service providers, an opportunity exists for them to become central to the broadband distribution of content. Carriers can provide “smart pipes” via a broadband service network which provides efficient and quality operations for both communication and content distribution. Peer-to-peer distribution schemes such as the Grokster or Kazaa networks have become widely used means for sharing digital content. The wide use of these types of peer-to-peer networks has also provided a basis for numerous copyright infringement lawsuits due to use of such networks to distribute copyrighted music, books and other digital content without the permission of the copyright owner. Thus, there is a need for a method and system that would enable the use of peer-to-peer digital content distribution scheme that would enable the compensation of content owners in exchange for their permission to distribute the content.

In prior systems, this problem has been solved using two techniques. In a first technique, consumers copy the digital content to removable storage media (e.g., floppy disk, CD-ROM, USB drive) and then transfer the content to another device. In a second technique, consumers connect the device to a network (e.g., IP-based) and then transfer files between the devices directly using a “proprietary” file transfer protocol. Both of these techniques leave it to the consumer to report the copying to the rights holder in order for the rights holder to be properly compensated. As such, much of the copying was done “illegitimately” without compensating the rights holder and could be done on a widescale basis.

### BRIEF SUMMARY OF THE INVENTION

The present invention concerns a system and method for enabling the controlled (i.e., tracked) transfer of digital content between devices so that digital content rights holders may be properly compensated.

The present invention uses the ability of a Digital Content Mediator (DCM) to track the distribution of digital content and authorize the transfer based on the specified policies for the identified content. The tracking involves authenticating the source and destination users/devices involved in the transfer. This tracking creates an undisputable audit trail that can be used for authorization and billing purposes. In addition, content that is moved within one home or between devices owned by the same person can be done for “free” as per the fair use provision of the copyright act. The DCM verifies that the devices are in the same home and/or owned by the same person and allows the free transfer.

In practice, the source and the destination need not be authenticated in order to certify the transfer. Authentication is needed if it is necesssary to know where the content from distributed from and to. For example, two users may decide to exchange content but do not wish to disclose their identities. They may be quite willing to pay a fee to ensure that the content is legitimate without disclosing their identities.

Peer-to-peer content sharing between devices in a legal manner is a relatively new concept and the use of a Digital Content Mediator for this application is not generally known. Also, most peer-to-peer applications today are performed via computer-based applications and are not directly via device to device. The invention is not limited to peer-to-peer networks. The system will work for any network in the continum of client/server, including peer-to-peer networks.

The present invention enables service providers to deploy content-related services that take advantage of peer-to-peer network characteristics such as scalability (so that a larger variety of content titles could be provided) and the absence of “hot spots” due to the distributed nature of the data so that no large servers are required and less server bandwidth is needed. Additionally, this invention enables service providers to generate an audit trail for all (including peer-to-peer) content transfers/distributions, which cannot be accomplished with most current peer-to-peer systems.

The invention will be more clearly understood when the following description is read in conjunction with the accompanying drawings.

### BRIEF DESCRIPTION OF THE DRAWINGS

FIG. 1 is a schematic block diagram of an architecture for providing Internet Protocol Television (“IPTV”) service without a DCM.

FIG. 2 is a schematic block diagram of an architecture for a digital content mediator (“DCM”) enabled peer-to-peer video-on-demand (VOD) service using a DCM.

### DETAILED DESCRIPTION

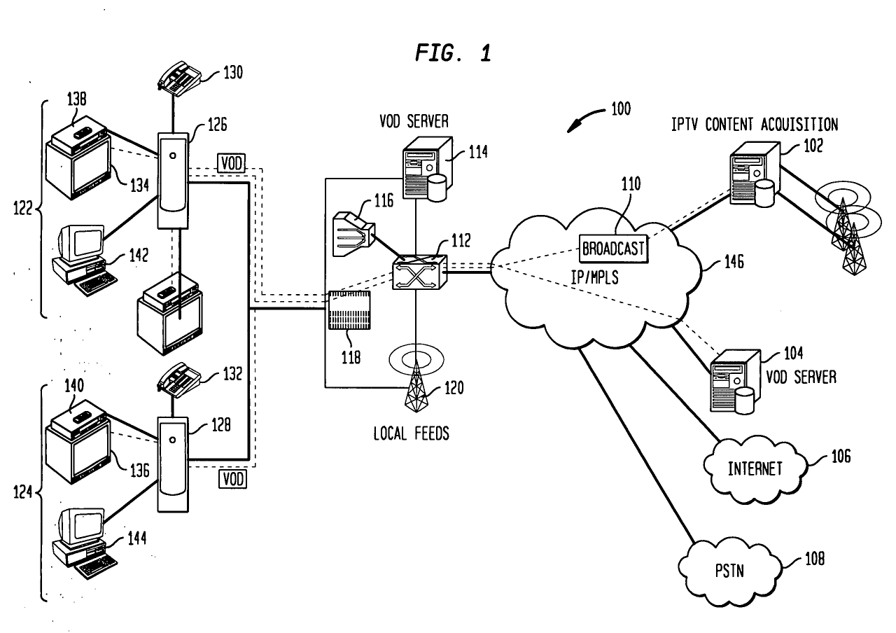

Referring now to the figures and to FIG. 1 in particular, there is shown a schematic block diagram of an architecture 100 for providing IPTV service. The content to be distributed may originate, for example, from an IPTV Content Acquisition 102, a video-on-demand (VOD) 104 server, the internet 106, or a Public Switched Telephone Network (PSTN) 108. The content from the IPTV Content Acquisition 102 is broadcast 110 to switch 112 from which the signal is provided to a VOD server 114, to access network multiplexer/de-multiplexer 116, to the access network termination block 118, and/or to local feeds 120. The content is then provided to one or more consumer devices at one or more locations 122, 124 via a respective VOD server 126, 128 associated with a respective location. At each location there may be, for example, a telephone 130, 132 for audio content, a monitor 134, 136 for viewing video content from a converter 138, 140 or a computer 142, 144 for receiving digital content.

Content from the VOD server 114 is provided to switch 126, 128 in a manner similar to that of the IPTV content. The content from the internet 106 and from the PSTN 108 are provided via Internet Protocol/MultiProtocol Label Switching (IP/MPLS) 146 to the switch 112 for storage or transmission in the same manner as the IPTV content. It will be apparent to those skilled in the art that the content may be provided by other than the IP/MPLS.

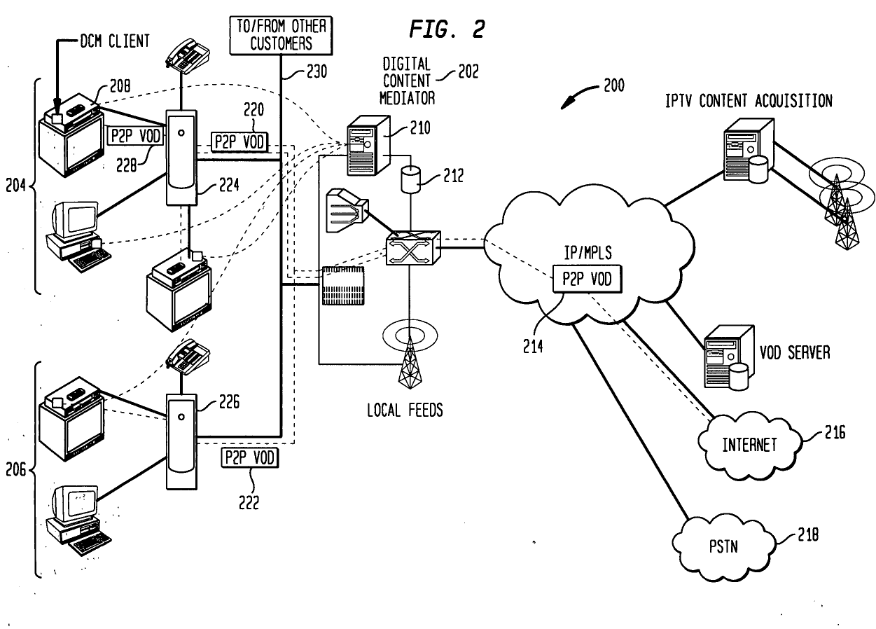

FIG. 2 shows a Digital Content Mediator 202 used to enable sharing of content in a peer-to-peer network 200 between users/devices in one home/domain 204 or between users/devices in different homes/domains 204, 206. A Digital Content Mediator 202 is described and illustrated, for example, in U.S. Patent Application Publication No. 2006/0173783, published on Aug. 3, 2006, entitled “System and Method for Authorized Digital Content Distribution”, which is incorporated herein by reference.

In one example, a digital content distribution system uses a Digital Content Mediator that includes a Digital Rights Management (DCM) Controller that performs a set of arbitrary tests against the transfer request from one user to another such as user A to user B. Assuming these tests are successful, the DCM Controller sends an encryption key to transferring user A. This encryption key E is taken from a table of encryption key/hash pairs which have been provided to the DCM Controller by an external authority such as the content rights holder. User A encrypts the content using they key provided by the DCM Controller and then calculates a hash over the encrypted form of the content E(X) and returns this value to the DCM Controller. On checking the returned hash against the hash from the table the DCM Controller knows that user A does indeed have the digital content X in good condition. The DCM Controller then instructs both users A and B that the transfer may proceed. The encrypted form of the content E(X) is transferred from A to B. Once the content transfer has completed B ensures that the received content has been physically written to non-volatile storage (to account for crashes etc. during the next step). B then calculates a hash over the received content and returns this value to the DCM Controller. If this value matches the value previously given then the transfer has been successful and the DCM Controller updates whatever central records are appropriate to assure that the rights owner is properly compensated, while also returning a decrypt key to B to allow it to decrypt the content. The central records comprise software on a general purpose computer that is capable of keeping track of the transfer of digital content and the payment for the digital content.

The application depicted in FIG. 2 is that of IPTV with a DCM 202. It will be apparent to those skilled in the art that the invention applies to other kinds of digital content and digital content transfer applications. The DCM 202 comprises client code that in the present example is located on the user device e.g., a set-top box or digital video recorder 208, a DCM server 210 (that resides in the service provider network), and the content information database 212 that is accessed by the DCM server.

In the peer-to-peer network shown in FIG. 2, the digital content is provided by a P2P VOD. The P2P VOD 214 provides digital content from the internet 216 or the PSTN 218. P2P VOD 220, 222 provides digital content from the digital content moderator 202 to the digital video recorder 224, 226. Another P2P VOD 228 provides digital content to the DCM client 208. Digital content is transferred to and from other users/customers via a bus 230. While the invention is described in conjunction with a peer-to-peer network, the invention is equally applicable when used in any client/server network.

In the example shown, a user with a Digital Video Recorder (DVR)224 in one home 204 wants to transfer to itself a video recorded by someone on DVR 226 in a different home 206. It is assumed that the the DVR 226 which initially recorded the program populates the content information database 212. This can be done by running a DCM hash algorithm to generate the unique content ID and include any necessary program broadcast information that can be obtained from the broadcast. The person who wants to watch the show, then uses his DVR 226 to “search” for the desired program title. The search may be performed using a conventional peer-to-peer network content searching algorithm. The person's DVR 224 with the embedded DCM client 208 then communicates with the DCM server 210 and the source DVR 226 also communicates with the DCM server 210 using, for example, the procedure described above to request a transfer of the recorded program. If the transfer is allowed then the content will be copied from one DVR 226 to the other DVR 224 and the DCM 202 will generate the appropriate accounting information, which the service provider will use to bill the user/customer (and possibly credit the source of the material), and use to provide as a record to the content rights owner. The DCM is also provided with information regarding instances where transfers of digital content may be performed without creating an obligation to pay the content owner. For example, if the content is transferred within a single home or location or for the purpose of creating a backup copy of the content or to create a permitted copy for a legitimate owner of the content. In this manner, the present invention provides that only approved or permitted transfers of digital content are performed, the rights owners are credited with the proper compensation, and an audit trail is generated for the transfer.

While there has been described and illustrated a system and method for peer-to-peer content sharing so that the digital content rights owner will be compensated, it will be apparent to those skilled in the art that variations and modifications are possible without deviating from the broad teachings and spirit of the present invention which shall be limited solely by the scope of the claims appended hereto.

What is claimed is:

1. A system, including a digital content mediator, to control the distribution of digital content from a first user in a client/server network to a second user in a client/server network, comprising:
a client/server network, including a DCM;
a device for recording digital content at a first user in the client/server network;
means for providing information regarding the recording to a content information database associated with the DCM;
means for locating the digital content recorded by the first user at a second user in the client/server network by searching the client/server network;
means for sending a request from the second user to the DCM for permission to transfer the recorded digital content from the first user to the second user; and
if the transfer is allowed, transferring the recorded digital content and generating the appropriate accounting information at the DCM in order to collect payment from the second user and to provide a record of the transfer to the owner of the digital content.

2. A system as set forth in claim 1, wherein the client/server network is a peer-to-peer network.

3. A method for enabling a client/server distribution of digital content from a first user to a second user through a client/server network using a digital content mediator (“DCM”) comprising the steps of:
providing a client/server network, including a DCM;
recording digital content on a device at a first user in the client/server network;
providing information regarding the recording to a content information database associated with the DCM;
locating the digital content recorded by the first user at a second user in the client/server network by searching the client/server network;
sending a request from the second user to the DCM for permission to transfer the recorded digital content from the first user to the second user; and
if the transfer is allowed, transferring the recorded digital content and generating the appropriate accounting information at the DCM in order to collect payment from the second user and to provide a record of the transfer to the owner of the digital content.

4. A method as set forth in claim 3, wherein the client/server network is a peer-to-peer network.
